(19) United States
(12) Patent Application Publication
(10) Pub. No.: US 2004/0225749 A1
(43) Pub. Date: Nov. 11, 2004

(54) Transformation of web site summary via taglibs

(76) Inventors: Gregory Pavlik, Shamong, NJ (US); David D'Orto, Cherry Hill, NJ (US); Neil Kenig, Mount Laurel, NJ (US); Peter H. Petersen, Trenton, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/434,509

(22) Filed: May 8, 2003

(51) Int. Cl. G06F 15/16

(52) U.S. Cl. 709/245

(57) ABSTRACT

In a distributed information processing and storage system, a method of transformation of a web site summary from Resource Description Framework Site Summary (RSS) format to a transformed format is provided. The method comprises defining a stylesheet, identifying the URL of the web site, and defining initial and transformed formats for the web site summary. The method further comprises inserting the defined stylesheet, initial and transformed formats, and URL in a web page, and executing the transformation when the inserted stylesheet, initial and transformed formats, and URL are encountered in the web page.

### CROSS-REFERENCE TO RELATED APPLICATIONS

This Application is related to co-pending, concurrently filed, and commonly assigned US Patent Applications Serial Number [Attorney Docket No. 100203197-] entitled “LOOK AND FEEL FOR WEB BASED APPLICATIONS USING TAGLIBS”; and Serial Number [Attorney Docket No. 100203191-1] entitled “RPC TYPE SOAP SERVICE ACCESS VIA TAGLIBS FOR DYNAMIC WEB CONTENT”; the disclosures of which are hereby incorporated herein by reference.

### BACKGROUND

Client/Server computing is a programming model, in which two or more entities partake in the solution of a given problem. A client is an entity that needs the solution and a server is an entity that, given enough information (typically in part from the client) can provide the answer. For example, a client, such as a part of an Internet portal like Yahoo™, needs the current price of the stock of a company, in order to display a user's portfolio. A server, such as Nasdaq™ or NYSE can provide the answer, as long as the client can provide it with the stock symbol for the company in question. A client is a software entity (which runs on a piece of hardware) that knows how to contact the server, which is another software entity (which also runs on some piece of hardware), provides enough information, such as a stock symbol, and receives the answer, for example the current price.

Client/server computing is often but not always distributed. In the distributed scenario, there are options, such as telephone or E-mail, for bridging the gap. While functionally equivalent, phone and E-mail communication employ different protocols.

One desirable attribute of clients and servers is that they be protocol independent. In the above example it is technically the client and the server who adapt to the protocol used for phone or E-mail communication. Often in client/server computing there will be proxies involved in the process. A client presents a question to an assistant, who contacts a server assistant, who in turn presents the question to the server; the answer then flows back the same route, but in the opposite direction. The assistants in this example are defined to be proxies, which make the client and server protocol independent, i.e., the proxies handle the protocol. Neither client nor server need know whether the communication was by phone, fax, or E-mail, such that the protocol is completely transparent to both.

Servers are often themselves also clients. If, hypothetically, a server did not know an answer, it could get that answer from someone else, for example a third party specialist. The key thing is that the client is not aware of this second client/server intermediary. While clients and servers might be rather nebulous entities, they all function in a relatively simple manner, exchanging information using proxies and a specific set of protocols.

To some extent contrary to popular belief, the Internet is not a single network per se; rather, it is vast conglomerate of separate networks that are interconnected, allowing a client to reach a server anywhere (the server may not wish to “speak” to the client, or they may not share the same protocol).

In an archetypal use of the Internet, a user needs a piece of information that is available on the Internet (for example, a company's address or phone number). The client is almost always a web browser, for example Internet Explorer™, Netscape™ or Opera. From the user's perspective, the browser is just another application that runs on his/her PC, Mac™ or UNIX™/Linux™ box. From a computing standpoint, the browser is actually a client.

The server, in this example, is generally a web server, such as Microsoft's IIS (Internet Information Server), Apache, or some other equivalent, usually at a company or organization's premises, or at a service provider. Unless the client and server (or their proxies) can agree on a protocol and a language, they cannot communicate. The overwhelmingly most used protocol on the internet is HTTP (HyperText Transfer Protocol), running on a base of a Transmission Control Protocol/Internet Protocol (TCP/IP) lower-level protocol. HTTP was conceived as a means for allowing the use of “hypertext” which embedded “hyperlinks” in digital documents to seamlessly link to additional information without “leaving” the current document. This mechanism is still the core of the Internet, as far as human users are concerned: a document contains links to other documents that (hopefully) relate in some way to the current document.

Since servers potentially can do many things, pointing a browser to www.company-name.com gets their “home page” or some portal-like screen that gives access to other pieces of information, e-commerce™, etc. However, even a simple, small PC-based server can host thousands of documents and hyperlinks, so a finer grained scheme is needed to uniformly locate these resources. The URL (Uniform Resource Locator) is the (often longwinded) complete address name. The browser and the server can often help alleviate most of the details for obtaining default information (such as the home page), but for specific documents, the full URL must be specified.

All URLs are made up of several parts:

1. The protocol (such as HTTP)

2. The server name (or TCP/IP address) (such as www.hp.com)

3. The server port number (usually 80)

4. The name of the document (or resource such as index.html).

Thus a fairly simple URL could look like:

http://www.hp.com/index.html

The port number was omitted since each protocol has a default, so for HTTP the real URL is:

http://www.hp.com:80/index.html

Using this simple string of text tells the browser to:

1. Use HTTP protocol.

2. Go to Dynamic Naming Service (DNS™) and find the TCP/IP address for www.hp.com

3. Open a TCP/IP network connection on port 80 to the server at that address.

4. Ask it for the document called index.html

5. Display the document.

Static content is content simply read from a file (like Word on Windows™ can read a Word document from, e.g., \My Documents\SomeLetter.doc, the web server can read the document from e.g. index.html). With static content, it is implied that no matter who requests the document, it is the same document that is read and sent, and because it resides in a file on a web server, it changes infrequently. Most people have gone to a web site and seen the notice on the bottom of the page: Last modified on xx/xx/xx. Static content is appropriate for encyclopedia data, where potentially vast amounts of facts (or opinions for that matter) need to be stored and made readily available. The content and documents are a set of files in a directory on the hard drive on the server. These files contain the information that the browser needs to display them, which for historical and other reasons is in HTML format. The actual contents of the document have been “marked up” in order to specify the format, such as paragraphs, fonts, tables, etc.

If the following HTML:

```
<html>
  <head>
    <title>Welcome to HTML!</title>
  </head>
  <body>
    <h2>Welcome to HTML!</h2>
    <p>Welcome to the world of HTML. Everything you see in
your web browser is made up of stuff like this...
  </body>
</html>
```

were typed into Windows'™ Notepad and saved to a file, such as welcome.html, upon double-clicking that file, Internet Explorer™ would open and display

Welcome to HTML!

with the words ‘Welcome to HTML!’ in the title bar, the markup is in the document to tell the browser how to format it—as in Internet Explorer™. Right-clicking in Internet Explorer™ and selecting the ‘View Source’ menu item, Notepad opens up and shows everything—including the markup.

However, static content has limitations—certainly the weather could not be presented using static content, nor could an e-commerce™ site be built using it, so a different technology is required. The technology at hand is dynamic content generation, which can be done using a number of programming models and languages. Dynamic content is often created on demand in response to the actual request; take the stock quote example—when one wants the latest quotes, not old ones from an hour ago or yesterday's quotes.

A web request is nothing more than a client sending a URL, a server reading markup text from a file and sending it back to the client. Importantly, the client, for example Internet Explorer™, does not know or care from where the server gets the HTML. Accordingly, the web server does not have to read it from a file, but could get it from elsewhere.

### SUMMARY

In one embodiment disclosed herein, in a distributed information processing and storage system, a method of transformation of a web site summary from Resource Description Framework Site Summary (RSS) format to a transformed format is provided. The method comprises defining a stylesheet, identifying the URL of the web site, and defining initial and transformed formats for the web site summary. The method further comprises inserting the defined stylesheet, initial and transformed formats, and URL in a web page, and executing the transformation when the inserted stylesheet, initial and transformed formats, and URL are encountered in the web page.

In another embodiment disclosed herein, a distributed information processing and storage system is provided. The system comprises a web browser, a web site summary associated with content accessible to the web browser via a URL, and a stylesheet operable to transform the web site summary from an initial RSS format into a transformed format. The system further comprises a web page communicatively accessible by the web browser, the web page containing inserted instructions operable to specify the stylesheet, the web site summary via the URL, the initial RSS format, and the presentation format.

In another embodiment disclosed herein, a distributed information processing and storage system is provided. The system comprises means for defining a stylesheet, means for identifying the URL of a web site, and means for defining initial and transformed formats for a web site summary of said web site. The system further comprises means for inserting the defined stylesheet, initial and transformed formats, and URL into a web page. The system further comprises means for executing a transformation of the web site summary from the initial format to the transformed format.

In another embodiment disclosed herein, computer-executable software code stored to a computer-readable medium is provided. The computer-executable software code comprises code for defining a stylesheet, code for identifying the URL of a web site, and code for defining initial and transformed formats for a web site summary of the web site. The computer-executable software code further comprises code for inserting the defined stylesheet, initial and transformed formats, and URL into a web page, and code for executing a transformation of the web site summary from the initial format to the transformed format.

### BRIEF DESCRIPTION OF THE DRAWINGS

FIG. 1 shows a simplified flow diagram depicting a method of providing a Tag series, in accordance with the present embodiments.

FIG. 2 is a block diagram schematically representing components in a distributed information processing and storage system, in accordance with the present embodiments.

### DETAILED DESCRIPTION

Most Internet standards are relatively old and have evolved over time. Many such standards may appear at face value to be arcane, ineffective or strange, but because the Internet is so distributed and diversified, changing these standards is a cumbersome and slow process.

An application server is a piece of software into which applications can be deployed—and in turn, these applications can generate HTML dynamically, based on who the user is and what information was supplied in the request—i.e. the URL and for example a form that was filled out by the user. An example of this is a weather application, in which a user keys in his/her zip code, for instance, and the weather application obtains the weather forecast for that area over the next few days. Clearly, it would be cumbersome to try to implement this application using static content, but an application server, capable of obtaining the information, can dynamically generate the content in response to a user request. Stock quotes follow similar guidelines, and an e-commerce™ application will generate content based on what the user is interested in purchasing and, e.g., showing the user's shopping cart and perhaps previous orders.

An application server is a complex piece of software that runs on a variety of different computing systems, such as Windows™ PCs, UNIX™/Linux™ servers and IBM mainframe computers. Application servers fall into categories of 1) Windows™ IIS based (basically Microsoft Net), 2) Java™ J2EE based, and 3) Apache plug-in based. J2EE stands for Java™ version 2 Enterprise Edition and is simply a set of standard Java™ components, used for enterprise computing. A J2EE application server is a standards-conforming large, complex piece of software into which applications, written in the Java™ programming language, can be deployed and accessed by users using a web browser, such as Internet Explorer™ or Netscape™. The user experience is in essence similar to the above example with static content, in that the user either types a URL or clicks a hyperlink (which contains a URL) and receives a response in the form of (typically) an HTML document that the browser displays. The difference is that the HTML in question did not come from a file, as in the static content example, but rather was generated dynamically by the application.

A typical application server allows the deployment of several applications at once, and any number (within certain practical limits) of users can interact with any of the applications simultaneously; for example, retrieving stock portfolio on Yahoo™ while another user checks local weather, also on Yahoo™.

A web application is usually a set of files, containing: 1) static content, such as images and perhaps HTML, 2) application code, known as Java™ class files, 3) application code, along with (typically) HTML markup in JSP™ files (described below in more detail), and 4) sundry configuration information, etc.

Web applications are often organized in directories (or folders), for example, a Letters folder, a Client folder, etc. to put files based on the category they fit. A typical E-mail system, such as Outlook™, also lets a user create folders and move E-mails into them. Outlook™ actually creates directories on the hard drive that match the folder names specified. In a typical web based application, called weather, a set of images might indicate the current cloudiness level (say, overcast, mostly cloudy, mostly sunny, and sunny). Once the weather application has received the weather forecast, it would translate the forecast level of cloudiness into an HTML link to the appropriate image file; e.g. the word “sunny” in the forecast could be translated to the file/images/sunny.gif.

The following URL is actually taken from the Yahoo™ forecast for Mt. Laurel, N.J., for a Friday, which is supposed to be mostly sunny:

<img src=“http://us.il.yimg.com/us.yimg.com/i/us/we/52/34.gif” width=52
height=52 alt=“Mostly Sunny” border=0>

The <img> markup is HTML that tells the web browser to go to the URL, specified by the src=“ . . . ” and display the image it retrieves. The alt=“. . . ” specifies the “tooltip” that pops up when the cursor hovers over the picture—in this case “Mostly Sunny”. The actual URL and directory- and image names are dependent on the actual server and application.

The image in the example is 34.gif; where gif stands for Graphics Interchange Format™, which is a very widely used image format, recognized by all browsers. Two other computer formats are .png and jpg.

Both web servers and application servers are capable of returning both HTML text documents and non-text image files. In fact, web servers and application servers can return any kind of file, including Word documents, MP3™ music files, movies, PDF files etc. HTML documents are often very large. For example, the Yahoo™ weather page discussed above is about 36000 characters. Creating these pages, whether statically or dynamically, can be time consuming.

Static HTML content is often written by specialists in web design. It is easy to author a simple page, as in the above example, but creating useful, well laid out pages is an art form. Good web page designers are rarely good software developers, and good software developers are rarely good web page designers. The following excerpt of Java™ code generates a simple web page that greets the user with either “good morning” or “good afternoon,” depending on whether the current time is before or after 12:00 noon.

```
Writer writer = response.getWriter( );
writer.println(“<html>”);
writer.println(“\t<head>”);
writer.println(“\t\t<title>Greetings</title>”);
writer.println(“\t</head>”);
writer.println(“\t<body>”);
Date date = new Date( );
if (date.getHours( ) < 12) {
  writer.println(“<p>Good Morning!”);
} else {
  writer.println(“<p>Good Afternoon!”);
}
writer.println(“\t</body>”);
writer.println(“</html>”);
```

Editing HTML can be strenuous, but in conjunction with Java™ code it becomes cumbersome, so a better, easier way was needed. JavaServer Pages (JSPS™) are simple text files, exactly like normal, static HTML files, but rather than a web server sending them directly to the client, a J2EE application server is needed, so that they can first be processed and executed. What this implies is that JSP™ pages are more than HTML; they conveniently bridge the gap between Java™ and HTML, but from the HTML authors' standpoint rather than the Java™ developers.

The above greeting example can be expressed in a JSP™ as:

```
<html>
    <head>
      <title>Greetings</title>
    </head>
    <body>
      <p>
      <%
Date date = new Date( );
if (date.getHours( ) < 12) {
  out.println(“Good Morning!”);
} else {
  out.println(“Good Afternoon!”);
}
      %>
    </body>
</html>
```

A JSP™ allows Java™ code to be embedded inside normal HTML markup, using the <% and %> markup. If a web browser received this unprocessed, it would not understand it. Thus, the application server needs to process the JSP™ before it can be executed; the result of the execution is the raw markup along with the output (i.e. either “Good Morning!” or “Good Afternoon!”) from the embedded Java™ code. The end result is a HTML document that the web browser can understand and display in exactly the same manner as if the HTML had come from a file.

Although JSPs™ are an order of magnitude easier to create and modify than the Java™ code, they still tend to become cumbersome as more complexity (and thus more Java™ code) is added to the files. It often reaches a point at which a Java™ developer and a web page designer have to sit together to create and modify JSPs™—clearly not an ideal situation.

In general, markups in the previous example, like </head> and </h2> are referred to as Tags. Their corresponding </head> and </h2> markup with the backslash are called end-Tags. The HTML standard defines a large set of Tags that any web browser is required to understand and process correctly; consequently, web page designers are very familiar with Tags and know how to “customize” them using tag attributes, such as src=“ . . . ” and alt=“ . . . ” on the <img> Tag. Since the application server processes the JSP™ page, Tags other than those standard in HTML can be inserted, and as long as the application server understands them, they can be executed. An example is the <% and %> Tags that the server uses to isolate the embedded Java™ code. A Tag is inherently associated with a JSP™. A feature of JSPS™ is the ability to define and use custom Tags, that neither the server nor the browser need to understand in advance, but that have meaning only in the context of some JSP™ and that is used, for example, as a template for presentation of content. One such set or library of custom Tags is known as a TagLib, short for Tag library. A TagLib may contain as few as one single Tag or literally hundreds of them. The actual TagLib is a file with a special format, understood by the application server, that basically contains two things, namely a description of all the custom Tags, which attributes they support, and the Java™ code that the application server will execute in place of the Tags.

Considering the greeting example above; rather than embedding the actual Java™ code in the JSP™, a Java™ developer can create a self-contained TagLib and give that to the web page designer, who can use it just as easily as standard HTML. The developer can for example create a “greeting” Tag that requires two attributes, namely an AM greeting and a PM greeting. All the web page designer needs to know is the name of the Tag and the required attribute names.

The JSP™ could thus look like this:

```
<% @taglib prefix=“hp” urn=“...” %>
<html>
  <head>
    <title>Greetings</title>
  </head>
  <body>
    <p><hp:greeting am=“Good Morning!” pm=“Good Afternoon!”/>
  </body>
</html>
```

The above example illustrates the separation of web design markup and Java™ code. TagLibs put the power of Java™ in the hands of web page designers.

As with other standards, HTML has evolved significantly over the years. A major area deals with the “look and feel” of web pages, which means the capabilities of the web designer to add color, pictures, different fonts and other formatting options, to allow for web pages that provide more functionality and in general are visually more attractive.

In order to accomplish this, certain capabilities were added to HTML, namely 1) the ability to specify the layout of text, images and other features, and 2) the ability to manipulate the appearance of text, images and other features.

“Layout” means how the different elements of a page are positioned on the screen (or printed hardcopy) in relation to one another. The elements of a HTML page, shopping cart, for instance, could be displayed in rows and columns using alternating colors and perhaps different size fonts for the product name, SKU number, price, etc. The underlying mechanism in HTML is known as cascading stylesheets (CSS). A feature of CSS is that styles, such as “Arial 12 point in italics with red foreground and blue background” can be stored in a separate file, such as commerce.css or customer-service.css. Each style has a name, and by referring to that name, the HTML element will have the corresponding style applied. The same style names can be used in several different .css files, so depending on which .css is referenced, the HTML may look one way or the other. Since they “cascade,” several .css files can be referenced in sequence, and when the browser looks for the correct style, in reverse order of their reference, such that a “cascade effect” is in play, one .css file can “override” a style declared in a previously referenced .css, which in turn can “override” the same style in yet another, previously referenced .css. By altering one or more .css files, a web page designer can drastically change the entire “look and feel” of a web page—or indeed an entire web site or web based application. There are other kinds of stylesheets that have very different functions.

One common mechanism other than the prevalent JSP™ for generating dynamic content is “templating,” meaning an incomplete web page that can act as a template for an entire page. The greeting example using “templating” for making it dynamic, could look like:

```
<html>
  <head>
    <title>Greetings</title>
  </head>
  <body>
    <p>$greeting$
  </body>
</html>
```

The $greeting$ template is placed where the real greeting (Good Morning! or Good Afternoon!) would be displayed. This is known as a place holder and—in the template—identifies its position. There are several “templating” systems or engines in use, which all work more or less the same.

XML is an acronym for eXtensible Markup Language, and like HTML is a derivative of SGML. However, unlike basically all other markup languages, including HTML, XML has no predefined set of Tags that are defined for the language. For example, HTML has <body>, <head>, <h2>, <p> and so on, but not so XML, which is “free for all.” However, in order for a document or file to be XML, it must be well formed, that is a document must conform to certain syntactical rules, but those rules do not dictate either the names or attributes of the Tags used.

For example, two businesses are doing business together, and whenever one wants to buy something from the other, a purchase order needs to be sent, and once processed, an invoice needs to be sent to the buyer. This document exchange could very well be done electronically and more or less automated, so the businesses could define two XML, document types—namely the purchase order and the invoice.

A simple purchase order, in XML, could look like:

```
<purchase-order>
  <product>
    <sku>ABC12345</sku>
    <price>$12.50</price>
    <quantity>1000</quantity>
  </product>
  <delivery>
    <location name=“Prod. Facility 1”>
      <address>
        <street>123 Main St.</street>
        <zip>12345</zip>
        <city>Springfield</city>
        <state>NJ</state>
      <address>
    </location>
  </delivery>
  <payment type=“transfer”>
    <amount>$12,500.00</amount>
  </payment>
</purchase-order>
```

The corresponding (oversimplified) invoice could look like:

```
<invoice>
  <product>
    <sku>ABC12345</sku>
    <price>$12.50</price>
    <quantity>1000</quantity>
  </product>
  <payment>
    <amount>$12,500.00</amount>
    <tax rate=“6%”>%750.00</tax>
    <total>$13,250.00</total>
  </payment>
</invoice>
```

The overall format is similar to HTML, except that the Tags are very application specific. The above documents are syntactically well formed, unlike much of HTML. XML, must be perfectly authored—otherwise it is not well formed and cannot (should not) be processed.

Further than being well formed, XML documents can also be described using either Document Type Definitions (DTD) or XML Schema, which are two relatively similar ways of describing the Tags and attributes (and to some extent values) along with the required/permitted Tag hierarchy. DTDs and Schemas allow the XML processor to validate that a document of a given type is both well formed and also valid with respect to the definition. Most XML documents are processed in two steps, namely, 1) parse the document, and 2) process the parsed result. Several standard parsers exist, and all J2EE application servers are required to have one installed, so Java™ web applications can rely on one being available.

XML can be used for substantially anything that requires the representation of some kind of data in some kind of format. Reasons to use XML include:

(1) It is platform, language and operating system agnostic. For example, an XML purchase order can be created on a Windows™ PC with a Microsoft Net application and sent to a supplier's J2EE Java™ purchase order application running on HP-UX™.

(2) Unlike many other formats, the document data and the format are contained in the same document. For example, ABC123412501000123 Main St. is not immediately obvious, whereas the exact same values in the above XML purchase order document make perfect sense.

(3) XML is human and machine producible and consumable; i.e., both software and humans can with relative ease construct XML documents and both humans and software can “understand” the documents.

XML namespaces are opaque names that serve to isolate and provide text. One potential problem with XML is that different entities may define the same Tags but quite possibly define different attributes and schema definitions. Also, as described below, it is often desirable to have XML documents of one type enclose XML documents of another type. If there are two or more definitions for, say, a payment, a client, or an entire purchase order or invoice, if two businesses exchange information (such as purchase orders and invoices) and both have a <client> Tag, each defined differently, namespaces can be used to identify which client Tag is being used. For example:

```
<purchase-order>
  ...
  <hp:client>
  ...
  </hp:client>
  ...
  <fulbright:client>
  ...
  </fulbright:client>
</purchase-order>
```

In the above example, the same document can now contain two different client Tags—an “HP” one and a “Fulbright” one, because they each belong to different namespaces. Because namespace names are arbitrary, ‘a’ and ‘b’ could produce the same result.

Remote Procedure Call (RPC) is a generic term for a client making a request to a remote (or distributed) server. Among many RPC mechanisms available. SOAP (Simple Object Access Protocol) is implemented by transmitting an XML document, usually using HTTP, and getting another XML document back. SOAP supports two types of client/server calls, namely, 1) RPC—the Remote Procedure Call, and 2) document (or message) exchange.

For RPC, all pertinent information, such as the name of the procedure to call (say, CalculateTax) and the necessary parameters (say $12,500.00 and 6%) are formatted into a SOAP XML document and sent to the remote server; here, the XML is parsed and the correct procedure is called with the supplied parameters, as in:

result=CalculateTax(12500, 0.06);

The result is then formatted into another SOAP XML document and returned to the client.

For document exchange, an XML document of any type is embedded inside a SOAP document and sent to the remote computer, where it's extracted, possibly parsed and passed to the actual server. The purchase order example fits well into this category; SOAP is used merely as a vehicle to get the purchase-order, invoice and sundry confirmation messages sent.

In order for SOAP clients and services to be as generic as possible, they do not themselves contain any SOAP-specific code. SOAP uses proxies, too, which are called bindings, which “bind” a request to a particular protocol, server and procedure name (if RPC). When making a SOAP request, the code doesn't “see” anything SOAP specific, which is handled by the bindings.

Web Services are servers that are accessible via the web, using SOAP. Consequently there are RPC-style web services and document exchange-style web services. A particular procedure, such as CalculateTax, in a particular web service on a particular machine is called an end point; it is where the SOAP message needs to be sent for processing.

Web Services Descriptor Language (WSDL) is XML with a particular schema, and WSDL documents contain all the detailed information about the web service, such as whether RPC or document exchange, available procedures, their parameters, and all their end-points.

XSL (eXtensible Stylesheet Language) allows the definition of a way to transform an XML document into something else, such as a different kind of XML, HTML, simply plain text, or even Java™ code. XSL is a set of rules that describe what to do when certain Tags are encountered in a document and what the transformed output will look like.

Two other types of XML documents, namely, Voice-XML and WML (Wireless Markup Language), were developed specifically for telephone voice-response systems and low-end wireless devices, such as PDAs and cell-phones. From an end-user point of view, Voice-XML and WML fulfill the same role as HTML does for “normal” web browsers. WML looks somewhat similar to HTML, but Voice-XML is quite different, since it must contain both the speech grammar, the words/touch-tones to recognize as well as the actual information, such as weather or stock quotes.

RSS (RDF Site Summary) is a lightweight multipurpose extensible metadata description and syndication format. RSS is an XML application, conforms to the W3C's RDF (Resource Description Framework) Specification and is extensible via XML-namespace and/or RDF based modularization. RDF basically deals with ontology systems to support the exchange of knowledge. Syndication in general means that one web site takes (borrows, leases, buys) some of its content from a syndication service, possibly somewhere else. For example, sports and news sites commonly use syndication, e.g., Yahoo™ news is mostly syndicated content from elsewhere.

UDDI (Universal Description, Discovery and Integration) is a registry in which web services are described. UDDI itself is a web service in the sense that the protocols used to talk to it are SOAP and HTTP. At a high level, UDDI can be viewed as a yellow-pages book to search for web services. A UDDI registry allows such searches, but using multiple categories and keywords. Also, the outcome of a yellow-pages search is often nothing more than a phone number and perhaps an address, whereas with UDDI the result of a search is among other things the WSDL document that not only explains what a web service can do but also how to communicate with it.

On the Internet, a handful of public UDDI registries exist that allow businesses and organizations to register their web services. Anyone can search these registries and find suitable web services that potentially fit their need. Since a UDDI registry is nothing more than a well-defined web service, private companies and organizations can elect to have one or more dedicated UDDI registries for in-house web services that are available for public consumption.

To use a web service, a UDDI is not mandatory. If the details (i.e., the URL and the WSDL) have been communicated by other means, the web service is still accessible and available for use, in the same manner that a caller who already knows a phone number does not have to look it up in order to call. Put slightly differently, UDDI is most often used during design-time (when the code is designed and written) and is most often not needed at run-time (when a user actually runs the code).

With the expected proliferation of web services using the SOAP protocol, web content will be produced increasingly by third party companies or organizations. Some archetypal examples discussed above are weather forecasts and stock quotes, but many other areas are equally applicable. Advantageously, web services using SOAP are well defined and described. The protocol is usually HTTP, and SOAP XML messages are sent/received in a well described manner. Importantly, web services are usually registered in one or more public UDDI registries, so they can very easily be found and accessed.

Further, a dichotomy exists between people who create web content (the authors) and people who write code (the developers), which has led to technologies like JSP™ and TagLibs. If very disparate information/content can be made available from a large number of sources to be used by web content authors, richer and more functional web applications can be developed without the need for developers.

In order for a web service to be useful, it must be registered somewhere—publicly or privately. It is commonly done in a UDDI registry (a few public ones exist—one of which is run by Hewlett-Packard (HP)). The actual information stored in the registry is among other things an XML document in the WSDL (Web Service Descriptor Language, usually pronounced “wis-del”) that describes that the web service can do (say, provide stock quotes or deliver a weather forecast) and how it must be called (what methods to invoke (say, getQuote), which parameters to supply (say, stockSymbol), and what the response is (say, stockPrice)). This is what makes up a RPC (Remote Procedure Call).

With a WSDL document, a developer can deduce how to format applicable SOAP messages and how to interpret the SOAP response from the web service. This is tedious, so most developers use one or more tools that will interpret the WSDL document and generate some code that will do the tedious work. Several vendors and open source initiatives supply these tools and what they actually generate is referred to as a proxy. With a proxy, the developer simply writes code that interacts with the proxy, which in turn handles the SOAP/XML/HTTP protocol translation details.

Accordingly, the use of web services traditionally requires code development and thus would invariably require a developer to spend time writing very specific code, and if later on changes are required, a developer would have to be involved again. One option would be for a developer to generate the proxy and write a TagLib for the particular web service. However, that does not solve the overall problem of developer involvement, namely, whenever a new, useful web service is discovered, An entirely new TagLib (or at least a new Tag) would have to be defined and developed.

In accordance with teachings of the present embodiments, a web content author uses a single, pre-developed TagLib to invoke any method on any web service. An author finds a suitable web service and, using a single TagLib, can invoke methods and obtain results without any code generation or developer involvement.

Resource Description Framework Site Summary (RSS) is a lightweight multipurpose extensible metadata description and syndication format for describing web site content, i.e. web site summaries, in eXtensible Markup Language (XML). A system and method are provided herein that allow presentation in a distributed information processing and storage system of RSS in multiple formats, e.g., HTML, WML, voice (VXML), based on a series 100 of Tags stored in Tag Libraries (TagLibs). Displaying an RSS-based set of hyperlinks is performed, for example, by defining a series of Tags:

<content: transform stylesheet = “/my.xs1”>
<content: include url/ = “http://www.hp.wm/rss.vxm1”/>
</content: transform>

in which XSL is used to transform RSS XML format to presentation XML format.

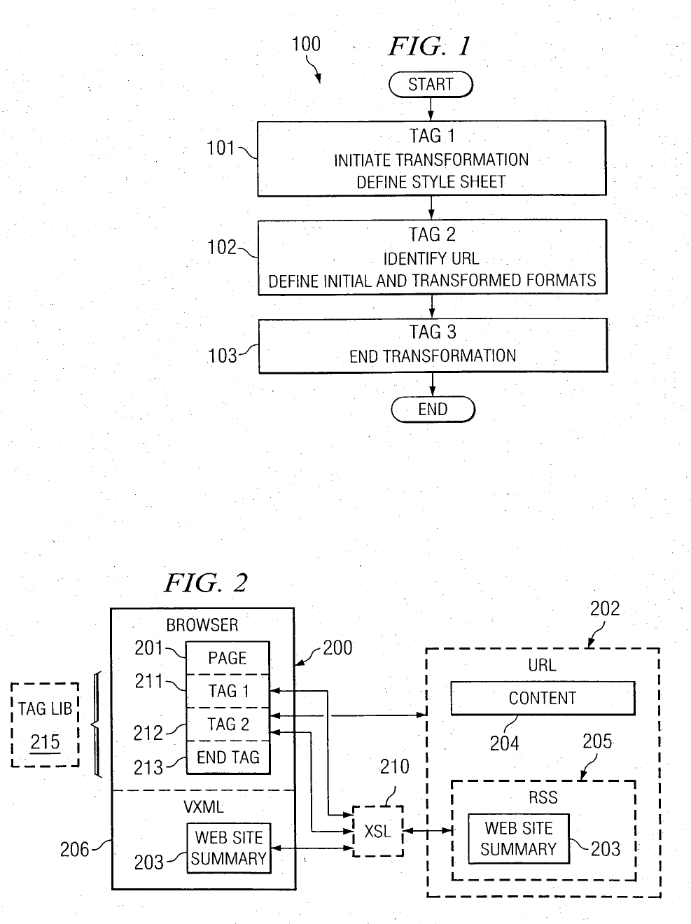

FIG. 1 shows a simplified flow diagram depicting method 100 of using a series of Tags, e.g., Tags 1-3, in accordance with the present embodiments. FIG. 2 is a block diagram schematically representing components in a distributed information processing and storage system, in accordance with the present embodiments. At step 101, first Tag 211 (Tag 1) initiates the transformation process and customizes the attribute of “stylesheet” to, for example, “/my.xsl”, wherever it is inserted in a web page, for example web page 201 in browser 200. XSL allows the definition of a way to transform an XML document into a different format, for example a different kind of XML, HTML, plain text, or Java™ code. XSL provides a standard set of rules that describe what to do when certain Tags are encountered in a document, e.g., web page 201, and how the transformed output will appear. In some embodiments, XSL 210 is used to transform a web site summary, for example web site summary 203, from RSS XML format 205 into a presentation XML format, e.g., voice XML (VXML).

At step 102, second Tag 212 (Tag 2) instructs web browser 200 to go to a URL, for example URL 202 identified as “http://www.hp.wm/rss.vxml/”, which transforms web site summary 203 associated with content 204 of URL 202 from initial RSS XML format 205 to transformed VXML voice presentation XML format 206 using XSL 210. Although VXML is used in this example, it is recognized that various other presentation formats may result from the transformation, for example HTML, WML, etc., as desired.

At step 103, third Tag 213 (Tag 3), containing the leading forward slash (/) symbol, provides an end-Tag denoting the end of XSL transformation Tag series 211-213. The above series of Tags is advantageously stored in a TagLib, for example TagLib 215, which is communicatively accessible by the client platform running browser 200. Tag series 211-213 can be written entirely without code, using only XML and JSP™ markup, which itself can be XML, whereas traditionally, the equivalent transformation would require writing code to APIs using a programming language. Tag 211-213 is generally specified by a page “developer,” which can be a programmer or a sophisticated web page designer. The rendered content type may be tailored in a number of ways independent of the Tag (e.g., in a nested Tag). The detailed XSL script determines the transformation/mapping of the RSS XML.

The transformation can be invoked by inserting an appropriate Tag series in a web page or other document, for example web page (e.g., JSP™) 201, which is provided to browser 200 by an application server. The details of transformation depend on the XSL script specified in the Tags. If a Tag 211-213 is not nested in some other Tag that alters the semantics, Tag execution is triggered by an HTTP request for web page 201, which at this point, along with the rest of the JSP™, has been rendered into Java™ code. Normally, for example, requests for VXML are generated by a voice portal that is acting in response to voice commands from a user via telephone or other voice communication means. The portal or gateway interprets the speech and turns it into an HTTP request that is sent to the application server. The application server may inspect the user agent information and decide that the device requires responses to be VXML format (for example, as opposed to HTML format when the browser is the client). If VXML is returned to a normal web browser, not specially prepared to handle VXML, only the text of the markup is displayed. This capability may then be used to supply the Tag with the appropriate URL in response to the appropriate XSL script. Transformation to VXML voice format is illustrative of the flexibility of Tag usage for format transformations of web site summaries.

After Tag series 211-213 has been embedded in web page 201, the client through browser 200 or other appropriate platform requests content 204 from URL 202, which the application server resolves to web page (JSP™) 201 When web page 201 is processed based on the client request, sequentially as encountered, text will be written to a response stream. As a Tag is encountered by browser 200, it accesses in TagLib 215 the code that was written to implement that Tag, and the code is executed. Web site summary 203 is then transformed using XSL 210 from initial RSS XML format 205 to presentation XML format 206, and can be published, for example at web browser 200.

The method as disclosed herein is simple, powerful, and allows web/HTML authors to provide dynamic site summaries using XML-based markup only. Accordingly, Tags provide the capability to add dynamic content in new ways to a simple page that otherwise looks very much like an XML document. Thus, an advantage over prior art is that a web page designer can use a markup language to dynamically transform from an initial format, e.g., RSS XML to another format, e.g., VXML. In some embodiments, it can transform from a first markup language format to a second markup language format, effectively using a markup language embedded in Tags.

Accordingly, a web page designer can, using tools and without writing code, define a web page that dynamically acquires a RSS description from any source on the Internet (network-accessible) or locally (on a filesystem) and render it for presentation in arbitrary ways, based on a transformation template that can be acquired dynamically from any network-accessible or local source. Traditionally, to accomplish the same result required a programmer to write complicated, network-aware Java code. No existing method accomplishes this simply or declaratively.

APPENDICES A, B, and C attached below illustrate examples of traditional XSL scripts for transforming from RSS XML format to other markup language formats.

### APPENDIX A

The following shows an example of a non-copyrighted traditional RSS document from the open source Apache Jetspeed project:

```
<?xml version=“1.0”?>
<rss version=“0.91”>
    <channel>
        <title>Apache Jetspeed</title>
        <link>http://jakarta.apache.org/jetspeed</link>
        <description>
        An Open Source Enterprise Information Portal.
        </description>
        <image>
            <title>Apache Jetspeed</title>
            <url>images/jetspeed-powered.gif</url>
            <link>http://jakarta.apache.org/jetspeed</link>
        </image>
        <item>
        <title>Jetspeed 1.4 Beta 3 Released</title>
        <link>http://jakarta.apache.org/builds/jakarta-jetspeed/release/
        v1.4b3</link>
        <description>
        Jetspeed v1.4 Beta 3 is available.
        </description>
        </item>
        <item>
            <title>Jetspeed Documentation</title>
            <link>http://jakarta.apache.org/jetspeed</link>
            <description>
            Jetspeed is an Open Source implementation of an Enterprise
            Information Portal.
            Jetspeed attempts to consume information from multiple
            resources on the Internet and helps the user manage large
            amounts of data. This information can come from multiple
            content sources: local files, local applications or remote
            HTTP sources.
            </description>
        </item>
        <item>
                <title>Jetspeed Tutorial</title>
                <link>http://www.bluesunrise.com/jetspeed-
                docs/JetspeedTutorial.htm</link>
                <description>Most comprehensive Jetspeed tutorial to
                date covering release 1.4b3.</description>
        </item>
    </channel>
</rss>
```

### APPENDIX B

The following shows an example of a traditional XSL script to transform to HTML:

```
    <?xml version=“1.0” encoding=“iso-8859-1” ?>
- <!--
Author: Kevin A Burton (burton@apache.org)
Author: Santiago Gala (sgala@hisitech.com)
Author: Raphael Luta (raphael@apache.org)
Author: Paul Spencer (paulspencer@mindspring.com)
$Id: rss.xsl,v 1.5 2001/12/29 04:09:24 paulsp Exp $
  -->
- <xsl:stylesheet xmlns:xsl=“http://www.w3.org/1999/XSL/Transform”
xmlns:rdf=“http://www.w3.org/1999/02/22-rdf-syntax-ns#”
xmlns:downlevel=“http://my.netscape.com/rdf/simple/0.9/” exclude-result-
prefixes=“downlevel rdf” version=“1.0”>
  <xsl:output indent=“yes” method=“html” omit-xml-declaration=
  “yes” />
  <xsl:param name=“itemdisplayed” select=“number(15)” />
  <xsl:param name=“openinpopup” select=‘“false’” />
  <xsl:param name=“showdescription” select=‘“true’” />
  <xsl:param name=“showtitle” select=‘“true’” />
  <xsl:param name=“showtextinput” select=‘“true’” />
- <xsl:template match=“/rss”>
- <div>
  <xsl:apply-templates select=“channel” />
  </div>
  </xsl:template>
- <xsl:template match=“/rdf:RDF”>
- <div>
  <xsl:apply-templates select=“downlevel:channel” />
  </div>
  </xsl:template>
- <xsl:template match=“channel”>
  <xsl:variable name=“description” select=“description” />
- <xsl:if test=“$showtitle = ‘true’ and $description”>
- <p>
  <xsl:apply-templates select=“image|../image” mode=“channel” />
  <xsl:value-of select=“$description” />
  </p>
  </xsl:if>
- <ul>
  <xsl:apply-templates select=“item[$itemdisplayed>=position( )]” />
  <ul>
- <xsl:if test=“$showtextinput = ‘true’”>
  <xsl:apply-templates select=“textinput” />
  </xsl:if>
  </xsl:template>
- <xsl:template match=“downlevel:channel”>
  <xsl:variable name=“description” select=“downlevel:description” />
- <xsl:if test=“$showtitle = ‘true’ and $description”>
- <p>
- <xsl:choose>
- <xsl:when test=“count(../downlevel:image)”>
  <xsl:apply-templates select=“../downlevel:image” mode=“channel” />
  <xsl:value-of select=“$description” />
  </xsl:when>
- <xsl:otherwise>
- <a>
- <xsl:attribute name=“href”>
  <xsl:value-of select=“downlevel:link” />
  </xsl:attribute>
- <xsl:if test=“$openinpopup = ‘true’”>
  <xsl:attribute name=“target”>_blank</xsl:attribute>
  </xsl:if>
  <xsl:value-of select=“$description” />
  </a>
  </xsl:otherwise>
  </xsl:choose>
  </p>
  </xsl:if>
- <ul>
  <xsl:apply-templates select=“../downlevel:item[$itemdisplayed>=
  position( )]” />
  </ul>
- <xsl:if test=“$showtextinput = ‘true’”>
  <xsl:apply-templates select=“downlevel:textinput” />
  </xsl:if>
  </xsl:template>
- <xsl:template match=“item”>
  <xsl:variable name=“description” select=“description” />
- <li>
- <a>
- <xsl:attribute name=“href”>
  <xsl:value-of select=“link” />
  </xsl:attribute>
- <xsl:if test=“$openinpopup = ‘true’”>
  <xsl:attribute name=“target”>_blank</xsl:attribute>
  </xsl:if>
  <xsl:value-of select=“title” />
  </a>
- <xsl:if test=“$showdescription = ‘true’ and $description”>
  <br />
  <xsl:value-of select=“$description” />
  </xsl:if>
  </li>
  </xsl:template>
- <xsl:template match=“downlevel:item”>
  <xsl:variable name=“description” select=“downlevel:description” />
- <li>
- <a>
- <xsl:attribute name=“href”>
  <xsl:value-of select=“downlevel:link” />
  </xsl:attribute>
- <xsl:if test=“$openinpopup = ‘true’”>
  <xsl: attribute name=“target“>_blank</xsl:attribute>
  </xsl:if>
  <xsl:value-of select=“downlevel:title” />
  </a>
- <xsl:if test=“$showdescription = ‘true’ and $description”>
  <br />
  <xsl:value-of select=“$description” />
  </xsl:if>
  </li>
  </xsl:template>
- <xsl:template match=“textinput”>
- <form action=“{link}”>
  <xsl:value-of select=“description” />
  <br />
  <input type=“text” name=“{name}” value=“” />
  <input type=“submit” name=“submit” value=“{title}” />
  </form>
  </xsl:template>
- <xsl:template match=“downlevel:textinput”>
- <form action=“{downlevel:link}”>
  <xsl:value-of select=“downlevel:description” />
  <br />
  <input type=“text” name=“{downlevel:name}” value=“” />
  <input type=“submit” name=“submit” value=“{downlevel:title}” />
  </form>
  </xsl:template>
- <xsl:template match=“image” mode=“channel”>
- <a>
- <xsl:attribute name=“href”>
  <xsl:value-of select=“link” />
  </xsl:attribute>
- <xsl:if test=“$openinpopup = ‘true’”>
  <xsl:attribute name=“target”>_blank</xsl:attribute>
  </xsl:if>
- <xsl:element name=“img”>
  <xsl:attribute name=“align”>right</xsl:attribute>
  <xsl:attribute name=“border”>0</xsl:attribute>
- <xsl:if test=“title”>
- <xsl:attribute name=“alt”>
  <xsl:value-of select=“title” />
  </xsl:attribute>
  </xsl:if>
- <xsl:if test=“url”>
- <xsl:attribute name=“src”>
  <xsl:value-of select=“url” />
  </xsl:attribute>
  </xsl:if>
- <xsl:if test=“width”>
- <xsl:attribute name=“width”>
  <xsl:value-of select=“width” />
  </xsl:attribute>
  </xsl:if>
- <xsl:if test=“height”>
- <xsl:attribute name=“height”>
  <xsl:value-of select=“height” />
  </xsl:attribute>
  </xsl:if>
  </xsl:element>
  </a>
  </xsl:template>
- <xsl:template match=“downlevel:image” mode=“channel”>
- <a>
- <xsl:attribute name=“href”>
  <xsl:value-of select=“downlevel:link” />
  </xsl:attribute>
- <xsl:if test=“$openinpopup = ‘true’”>
  <xsl:attribute name=“target”>_blank</xsl:attribute>
  </xsl:if>
- <xsl:element name=“img”>
  <xsl:attribute name=“align”>right</xsl:attribute>
  <xsl:attribute name=“border”>0</xsl:attribute>
- <xsl:if test=“downlevel:title”>
- <xsl:attribute name=“alt”>
  <xsl:value-of select=“downlevel:title” />
  </xsl:attribute>
  </xsl:if>
- <xsl:if test=“downlevel:url”>
- <xsl:attribute name=“src”>
  <xsl:value-of select=“downlevel:url” />
  </xsl:attribute>
  </xsl:if>
  </xsl:element>
  </a>
  </xsl:template>
- <!-- We ignore images unless we are inside a channel
  -->
  <xsl:template match=“image” />
  <xsl:template match=“downlevel:image” />
  </xsl:stylesheet>
```

### APPENDIX C

Exhibited below is an example of a traditional XSL template that transforms a RSS feed to a deck of WML cards:

```
  <?xml version=“1.0” encoding=“iso-8859-1” ?>
- <!--
Author: Kevin A Burton (burton@apache.org)
Author: Santiago Gala (sgala@hisitech.com)
Author: Raphael Luta (raphael@apache.org)
    SGP: Changed to support quoting of $ as $$ to avoid problems under
    WML
$Id: rss-wml.xsl,v 1.5 2001/02/27 16:26:54 sgala Exp $
  -->
- <xsl:stylesheet xmlns:xsl=“http://www.w3.org/1999/XSL/Transform”
xmlns:rdf=“http://www.w3.org/1999/02/22-rdf-syntax-ns#”
xmlns:downlevel=“http://my.netscape.com/rdf/simple/0.9/” exclude-result-
prefixes=“downlevel rdf” version=“1.0”>
  <xsl:output indent=“yes” method=“xml” omit-xml-declaration=“yes” />
  <xsl:param name=“itemdisplayed” select=“number(5)” />
  <xsl:param name=“showdescription” select=“‘false’” />
  <xsl:param name=“showtitle” select=“‘false’” />
- <xsl:template match=“/rss”>
  <xsl:apply-templates select=“channel” />
  </xsl:template>
- <xsl:template match=“/rdf:RDF”>
  <xsl:apply-templates select=“downlevel:channel” />
  </xsl:template>
- <xsl:template match=“channel”>
  <xsl:variable name=“description” select=“description” />
- <card id=“channel”>
- <p>
  <xsl:apply-templates select=“title” />
- <xsl:if test=“$showtitle = ‘true’ and $description”>
  <br />
  <xsl:apply-templates select=“$description” />
  </xsl:if>
  </p>
  <xsl:apply-templates select=“item[$itemdisplayed>=position( )]” />
  </card>
  </xsl:template>
- <xsl:template match=“item”>
  <xsl:variable name=“description” select=“description” />
- <p>
- <a href=“{link}”>
  <xsl:apply-templates select=“title” />
  </a>
- <xsl:if test=“$showdescription = ‘true’ and $description”>
  <br />
  <xsl:apply-templates select=“$description” />
  </xsl:if>
  </p>
  </xsl:template>
- <xsl:template match=“downlevel:channel”>
  <xsl:variable name=“description” select=“downlevel:description” />
- <card id=“channel”>
- <p>
  <xsl:apply-templates select=“downlevel:title” />
- <xsl:if test=“$showtitle = ‘true’ and $description”>
  <br />
  <xsl:apply-templates select=“$description” />
  </xsl:if>
  </p>
  <xsl:apply-templates select=“../downlevel:item[$itemdisplayed>=
  position( )]” />
  </card>
  </xsl:template>
- <xsl:template match=“downlevel:item”>
  <xsl:variable name=“description” select=“downlevel:description” />
- <p>
- <a href=“{downlevel:link}”>
  <xsl:apply-templates select=“downlevel:title” />
  </a>
- <xsl:if test=“$showdescription = ‘true’ and $description”>
  <br />
  <xsl:apply-templates select=“$description” />
  </xsl:if>
  </p>
  </xsl:template>
- <xsl:template match=“text( )”>
- <xsl:call-template name=“dollar-cleaner”>
- <xsl:with-param name=“chars”>
  <xsl:value-of select=“.” />
  </xsl:with-param>
  </xsl:call-template>
  </xsl:template>
- <xsl:template name=“dollar-cleaner”>
  <xsl:param name=“chars” />
- <xsl:choose>
- <xsl:when test=“contains($chars,‘$’) and not(starts-with(substring-
after($chars,‘$’), ‘$’))”>
  <xsl:value-of select=“substring-before($chars,‘$’)” />
  $$
- <xsl:call-template name=“dollar-cleaner”>
- <xsl:with-param name=“chars”>
  <xsl:value-of select=“substring-after($chars,‘$’)” />
  </xsl:with-param>
  </xsl:call-template>
  </xsl:when>
- <xsl:otherwise>
  <xsl:value-of select=“$chars” />
  </xsl:otherwise>
  </xsl:choose>
  </xsl:template>
  </xsl:stylesheet>
```

What is claimed is:

1. In a distributed information processing and storage system, a method of transformation of a web site summary from Resource Description Framework Site Summary (RSS) format to a transformed format, said method comprising:
defining a stylesheet;
identifying the URL of said web site;
defining initial and transformed formats for said web site summary;
inserting said defined stylesheet, initial and transformed formats, and URL in a web page; and
executing said transformation when said inserted stylesheet, initial and transformed formats, and URL are encountered in said web page.

2. The method of claim 1 wherein said stylesheet, initial and transformed formats, and URL are inserted via Tags.

3. The method of claim 2 wherein said stylesheet, initial and transformed formats, and URL inserted in said web page are encountered sequentially by an application server in response to a client request.

4. The method of claim 2 wherein said stylesheet, initial and transformed formats, and URL are inserted using extensible Markup Language (XML).

5. The method of claim 2 wherein said stylesheet, initial and transformed formats, and URL are inserted using JavaServer Page (JSP™) markup.

6. The method of claim 2 wherein said Tags are stored in a Tag Library (TagLib).

7. The method of claim 1 wherein said defined stylesheet uses extensible Stylesheet Language (XSL).

8. The method of claim 1 wherein said transformed format is selected from the group consisting of HyperText Markup Language (HTML), Wireless Markup Language (WML), Java™ code, plain text, and voice.

9. The method of claim 1 wherein said executing comprises transforming said web site summary from Resource Description Framework Site Summary (RSS) format into said transformed format using XSL.

10. The method of claim 1 wherein said transformation is performed without writing code requiring a programming language.

11. A distributed information processing and storage system comprising:
a web browser;
a web site summary associated with content accessible to said web browser via a URL;
a stylesheet operable to transform said web site summary from an initial RSS format into a transformed format; and
a web page communicatively accessible by said web browser, said web page containing inserted instructions operable to specify said stylesheet, said web site summary via said URL, said initial RSS format and said presentation format.

12. The system of claim 11 further comprising Tags operable to insert said instructions into said web page.

13. The system of claim 12 wherein said Tags are inserted using eXtensible Markup Language (XML).

14. The system of claim 12 further comprising a Tag Library (TagLib) operable to store said Tags.

15. The system of claim 12 wherein said instructions contain no code requiring use of a programming language.

16. The system of claim 11 wherein said stylesheet is operable to use eXtensible Stylesheet Language (XSL).

17. A distributed information processing and storage system comprising:
means for defining a stylesheet;
means for identifying the URL of a web site;
means for defining initial and transformed formats for a web site summary of said web site;
means for inserting said defined stylesheet, initial and transformed formats, and URL into a web page; and
means for executing a transformation of said web site summary from said initial format to said transformed format.

18. The system of claim 17 comprising means for said inserting said stylesheet, initial and transformed formats, and URL via Tags.

19. The system of claim 18 comprising means for encountering said stylesheet, initial and transformed formats, and URL inserted in said web page sequentially via an application server in response to a client request.

20. The system of claim 18 comprising means for inserting said stylesheet, initial and transformed formats, and URL via eXtensible Markup Language (XML).

21. The system of claim 18 comprising means for inserting said stylesheet, initial and transformed formats, and URL via JavaServer Page (JSP™) markup.

22. The system of claim 18 comprising means for storing said Tags in a Tag Library (TagLib).

23. The system of claim 17 comprising means for defining said stylesheet using extensible Stylesheet Language (XSL).

24. The system of claim 17 wherein said transformed format is selected from the group consisting of HyperText Markup Language (HTML), Wireless Markup Language (WML), Java™ code, plain text, and voice.

25. The system of claim 17 comprising means for transforming said web site summary from Resource Description Framework Site Summary (RSS) format into said transformed format using XSL.

26. The system of claim 17 comprising means for said transformation without writing code requiring a programming language.

27. Computer-executable software code stored to a computer-readable medium, said computer-executable software code comprising:
code for defining a stylesheet;
code for identifying the URL of a web site;
code for defining initial and transformed formats for a web site summary of said web site;
code for inserting said defined stylesheet, initial and transformed formats, and URL into a web page; and
code for executing a transformation of said web site summary from said initial format to said transformed format.

28. The computer-executable software code of claim 27 comprising code for said inserting said stylesheet, initial and transformed formats, and URL via Tags.

29. The computer-executable software code of claim 28 comprising code for encountering said stylesheet, initial and transformed formats, and URL inserted in said web page sequentially via an application server in response to a client request.

30. The computer-executable software code of claim 28 comprising code for inserting said stylesheet, initial and transformed formats, and URL via eXtensible Markup Language (XML).

31. The computer-executable software code of claim 28 comprising code for inserting said stylesheet, initial and transformed formats, and URL via JavaServer Page (JSP™) markup.

32. The computer-executable software code of claim 28 comprising code for storing said Tags in a Tag Library (TagLib).

33. The computer-executable software code of claim 27 comprising code for defining said stylesheet using extensible Stylesheet Language (XSL).

34. The computer-executable software code of claim 27 wherein said transformed format is selected from the group consisting of HyperText Markup Language (HTML), Wireless Markup Language (WML), Java™ code, plain text, and voice.

35. The computer-executable software code of claim 27 comprising code for transforming said web site summary from Resource Description Framework Site Summary (RSS) format into said transformed format using XSL.

36. The computer-executable software code of claim 27 comprising code for said transformation not requiring a programming language.
